(19) United States
(12) Patent Application Publication
(10) Pub. No.: US 2025/0240074 A1
(43) Pub. Date: Jul. 24, 2025

(54) Method of Adapting Wireless Network Beamforming to Antenna With Fixed Multiple Beams

(71) Applicant: Matsing, Inc., Irvine, CA (US)

(72) Inventors: Richard Braithwaite, Orance, CA (US); Serguei Matitsine, Dallas, TX (US); Anthony DeMarco, Leadville, CO (US); John Stewart Wilson, Huntington Beach, CA (US)

(21) Appl. No.: 18/926,762

(22) Filed: Oct. 25, 2024

Related U.S. Application Data
(60) Provisional application No. 63/623,135, filed on Jan. 19, 2024.

(51) Int. Cl. H04B 7/06

(52) U.S. Cl. CPC H04B 7/0626; H04B 7/0639

(57) ABSTRACT

Systems, methods, and devices are described for adapting multiple-element-array beamforming systems to work with passive multiple beam antennas, such as a RF lens. Such adaptations are implemented by hardware, by software, or combinations thereof. Hardware-based adaptations include introducing a reverse-beam-forming network in combination with traditional beam forming radios. Software-based adaptations include configuring a processor to interface with standard radio heads and an RF lens antenna to deliver beam-forming functionality. Codebook feedback is made compatible with lens beamforming without changing the user equipment, by modifying the CSI reference signals sent by the gNodeB to compensate for the unnecessary discrete Fourier transform operation.

This application claims the benefit of priority to U.S. provisional application No. 63/623,135 filed on Jan. 19, 2024. This and all other referenced extrinsic materials are incorporated herein by reference in their entirety.

### FIELD OF THE INVENTION

The field of the invention is wireless antennas, including passive narrow beam antennas using RF lenses.

### BACKGROUND

The following description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Advanced wireless systems (such as “beamforming” systems) include antennas with the ability to scan a narrow beam over the coverage sector. This must be done electronically as air interface standards such as 5G allow for separate beam states thousands of times per second. With demand for data—including video streaming, constant sharing of media rich social media content, and file transfers—ever increasing, more advanced air interface standards include the capability to briefly produce high gain focused beams that either scan or change beam characteristics including position, gain, beam widths, and null and side lobe characteristics based on what the network requires at that time.

This “beamforming” approach typically utilizes multi-element array antennas (i.e. 8×8 element array) in order to produce a single beam which can scan, change in beamwidth (become more narrow or wider) for a given coverage sector depending on what is required at the time. One key advantage of this approach, as opposed to having multiple beams on at the same time for a given coverage area (or a given sector), is the reduced interference from neighboring beams (improved signal-to-noise ratio) this results in higher channel quality index (CQI) and faster through-put for users. Through-put is also increased due to increased gain by having a narrow beam. Such an approach utilizes fewer radio resources (in some cases a single radio) as opposed to having multiple beams on at the same time each using a radio.

These systems use multiple-element arrays to produce the desired beam, they suffer from several drawbacks: limited scanning angle (limited coverage sector), narrow frequency band, beam-width stability, and high power consumption, amongst others. Since such “beamforming” systems use active or passive multiple element phased array antennas, they require all transmitter/power amplifiers to be “on” to form the required beam. This leads to high power consumption regardless of need. To create a narrower beam, more elements in the array are needed to be powered on, this increases power consumption.

The maximum power of the array antenna occurs when all active elements are at maximum power. For a single beam, the direction is controlled by phase shifts within the mapping of a single data stream to the elements. That mapping is a weight set, composed of both amplitude and phase coefficients applied to the array, which is referred to as a precoding matrix in 5G. For maximum array power, the coefficients of the precoding matrix have a constant amplitude with different phase shifts. There is often a desire to taper the amplitude near the edge of the array to reduce sidelobes, but that decreases the maximum power in the boresight direction and widens the beam. The amplitudes of the tapered weights are unity at the center of the array and zero at the edges resulting in a 2 dB loss in maximum array power. This inefficient use of weights requires maximum power of the elements to be over-specified, further increasing the power consumption.

An array antenna can generate multiple beams, but it comes with significant limitations. The beams must share the available power, so at best, the maximum power of the individual beams drops by 10*log 10(Nbeams) where Nbeams is the number of beams transmitted simultaneously. This assumes that the beams are orthogonal. Overlap between neighboring beams reduces the radiation efficiency, resulting in a larger drop in the maximum beam power. The beam power losses and degradations become more pronounced as more beams are added. The maximum element power must be over-specified by a significant margin to accommodate the transmission of multiple beams.

There is a limit to the number of useful beams that can be sent simultaneously by an array antenna. Beams whose boresights have minimal overlap with neighboring beams are desired to minimize interference at the UE being serviced. In general, the number of minimally overlapping beams possible is less than or equal to the number of elements in the array; however, the beams would be orthogonal and equally-spaced. The practical limit on the number of beams used simultaneously is 25% of the number of elements in the array.

There is a fundamental limitation for producing multiple beams in close proximity. If beam directions are too close together the radiated pattern merges the two beams into one beam with a large width. This is not unlike tapering the precoding coefficients near the edges of the array, which reduces the maximum power available.

All these undesirable aspects to wireless network beamforming, including 5G beamforming, can be avoided using a multiple beam antenna that does not rely on an array of closely spaced, properly phased, radiating elements. One embodiment, but not the only possible embodiment, is an RF lens based multiple beam antenna where each beam is associated with a single radiating feed.

RF lens-based antennas (single or multiple beam) provide several performance advantages compared to traditional multi-element array antennas. These include consistent pattern performance over azimuth and elevation (wide scanning angle), high isolation between beams, and consistent performance over wide frequency range. Certain types of RF Lens antennas (such as those utilizing single Luneburg lens and others) have no (or very minimal) scan loss and no, or very minimal, grating lobes. Scan loss in traditional scanning antennas (such as multiple element array) results in gain loss and wider beams. Grating lobes typically severely degrade multiple beam antenna performance outside a restricted scanning range as they cause interference and reduce signal-to-noise ratio. The side lobes of the RF lens antenna are low by design, typically 4-6 dB lower than the equivalent multiple element array.

RF lens based multiple beam base station antennas have seen increasing use in wireless networks in the past decade. Used both outdoors in macro cells and outdoor venues and indoor in large convention halls and sports venues, the typical arrangement is that each set of beams in a given direction represents a sector and a radio designed for either 2 or 4 input/output ports is connected to each beam set. In the case of 4 port radios two sets of dual polarized antenna beams aligned for the same coverage are used, typically by stacking two identical lenses horizontally or vertically. As such they are primarily used as multiple-beam antennas which have multiple beams “on” or active at the same time (each beam with its own radio).

RF lens based multiple beam antennas are typically not used for beam scanning antennas (beam forming) like those used in some 5G air interface standard implementations because such implementations have been designed to work with multiple element array antennas to create the necessary beam(s) as required by the network, whereas RF lens antennas have multiple fixed beams created using an RF lens. For this situation an RF lens solution could work if a network feature is added to reverse the beam forming function either by hardware, software, or a combination of hardware and software. Taught here is the concept of reverse beam former (RBF). Three possible hardware RBF embodiments taught here include a butler matrix, a Rotman lens and a novel parallel plate approach.

For a set of fixed beams, the RF lens has a distinct advantage over the array antenna. The beams have different feeds with a single power source for each beam transmitted simultaneously. There is no reduction in maximum power for a beam in a multiple beam application compared to a single beam application. UEs at the cell edge can be serviced simultaneously with nearby UEs on different beams requiring high throughput.

The RF lens approach and array antenna approach have different characteristics with respect to throughput, coverage, and capacity. The array antenna can have multiple beams supporting independent 5G layers, but the maximum transmitted power per beam drops. High capacity is possible if all the UEs are near the gNB. This can be viewed as an undesired shrinkage of the cell coverage. To service a UE near the cell edge, a single beam must be used to get enough power, which prevents any UEs on different beams from being serviced at the same time. This is a limitation of the array antenna, but not the lens beamformer that powers each beam independently.

Beamforming, in general, involves the selection of the beam to best service a UE. In 5G, it is done based on downlink channel estimates, where channel refers to the air interface between the antennas of the gNB and UE. Codebook-based feedback is used as an option in 5G to provide channel state information (CSI). The codebook reduces the overhead of the feedback by sending the index of the dominant beam, which the UE estimates using CSI reference signals sent by the gNB and information about the array antenna. The codebook is optimized for array antennas, introducing a discrete Fourier transform (DFT) operation to convert received CSI-RS into beam directions.

A fixed multiple beam antenna solution needs to be compatible with the 5G system. The DFT is not required but it is done by the UE as part of the 5G specification. This presents a compatibility issue.

### SUMMARY OF THE INVENTION

The inventive subject matter provides apparatus, systems, and methods to solve the limitations in a traditional multiple-element-array beamforming system (narrow scanning angle, narrow band, high grating lobes, high power) by adapting the system to work with an RF lens (or any other passive multiple beam antenna) instead of a traditional multi-element-array. Several methods are introduced including adaptation through hardware (by introducing a reverse-beam-forming network in combination with traditional beam forming radios), as well as adaptation through software (through configuring a processor to interface/work with standard radio heads and a RF lens antenna to deliver beam-forming functionality).

This invention proposes methods to make codebook feedback compatible with lens beamforming without changing the UE. The approach modifies the CSI reference signals sent by the gNB to compensate for the unnecessary DFT operation.

One such approach is where a standard RF lens antenna is used with one of several RBF networks which can be passive networks that connect to beam forming radios. In this instance a beam-forming radio, designed to work with a beam-forming network (BFN) and a multiple-element-array, can be instead connected to an RBF network and an RF lens to produce Lens Beam Forming (LBF).

In one embodiment separate beams can be created by the RF lens as beams of a scanning array and adapt network beam selection approaches that use typical N×M beam forming networks (BFNs) to work in reverse compared to their usual implementation. This allows for beam-forming radios to be used with “Reverse Beam Forming Networks” and an RF Lens (instead of beam forming radios being used directly with a multiple-element array) to provide the same functionality but with the added advantages of having a RF Lens instead of an array.

Approaches to achieve Lens Beam Forming include using software configuration, hardware configuration, or both, such that a processor (i.e. baseband unit) can interface with standard radio heads to deliver beamforming functionality without having to use a multi-element array. This approach for use in applications including 5G beam scanning (and beamforming) uses traditional 4×4 radio units and configures the base band processing unit to route signals to the beam required for signaling broadcast and active state user equipment (UE). Allowing a RF lens antenna to have scanning and beam forming capabilities and providing the benefit of having wider scanning angle (able to cover wider sector), wider frequency range and potentially less power consumption than a traditional multi-element array antenna beamforming system.

In terms of power consumption, a key advantage to using an RF lens antenna for lens beam forming is the beams are formed passively (on only when they need to be on) and provide a much lower power consumption option compared to traditional phased array beamforming. How narrow of a beam does not impact power consumption when using a RF lens antenna (or other passive multiple beam antenna), only the beam needed at a given time uses power. This is a key advantage over beam-forming multi-element array system where to create a narrower beam, more elements are needed to be powered on in the array (to create a larger aperture and thus narrower beam) and as such use more power. The narrower the beam, the more power, whereas with the proposed solution, regardless of how narrow your beam, only that one beam is “on” at a time thus greatly reducing power consumption.

Further key advantages include the ability to dynamically add capacity when needed. Such a system can easily be scaled to allow for multiple or single radio depending on capacity requirements. This allows the same antenna system to operate multiple radios dynamically (can have single beam with single radio on, or multiple beams each with own radio on).

### BRIEF DESCRIPTION OF THE DRAWINGS

FIG. 1 depicts a conceptual view of the general arrangement of a prior art UE within a sector containing multiple beams from a wireless tower.

FIG. 2 depicts a prior art arrangement of an antenna using a prior art Beam-Forming Network (BFN).

FIG. 3A is a schematic of a prior art Butler Matrix.

FIG. 3B depicts two examples of RF component networks used as Reverse Beam Formers (RBF).

FIG. 4 shows the concept of reverse beam former.

FIGS. 5A-B shows an example of an RF lens multiple beam antenna.

FIG. 6 depicts a prior art RF lens based beamformer system.

FIG. 7 depicts a four-beam representation covering a 120 degree sector.

FIGS. 8A-B depict a two-beam and four-beam switching arrangement.

FIGS. 9A-C depict two and three-beam switching arrangements.

FIGS. 10A-C depict a four-beam switching arrangement.

FIG. 11 depicts a narrow three-beam arrangement with scanning.

FIG. 12 depicts a two-dimensional 4×4 multiple beam system.

FIG. 13 depicts a downlink transmission chain for a MIMO system.

FIG. 14 depicts a flow chart of steps utilized in the inventive subject matter.

FIG. 15 depicts a flow chart of steps utilized in the inventive subject matter.

FIG. 16 depicts a CSI arrangement when using an RF lens antenna.

FIG. 17 depicts one codebook arrangement and resulting DFT result. This is a typical result for the CSI arrangement shown in FIG. 16, which produces an incorrect beam selection.

FIG. 18 depicts an alternative codebook arrangement with phase gradient and resulting DFT result. This is a desired result, which produces a correct beam selection.

FIG. 19 depicts a variation on FIG. 16 with modified set of CSI inputs to be used in an RF lens multiple beam arrangement. This modified CSI arrangement produces the desired results shown in FIG. 18.

### DETAILED DESCRIPTION

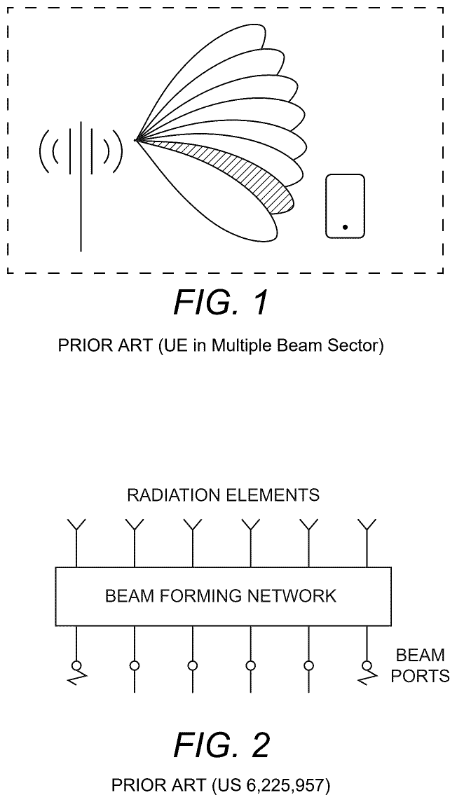

This invention describes different ways to adapt a multiple beam RF lens antenna (or any other passive multiple beam antenna) to work with 5G (and other) interface standards by adapting it to work like a scanning array to create a Lens Beam Forming (LBF) system which provides similar functionality and advantages as standard beam-forming using an array of elements, but with the advantages of using an RF Lens. FIG. 1 shows conceptual user equipment (UE) within a wireless sector consisting of multiple beams.

A Beam Forming Network, or BFN, is a common circuit component in phased array antennas used to scan beams in one or more directions (i.e. azimuth scan only, elevation scan only, or combinations of azimuth and elevation scanning). FIG. 2 shows a prior art arrangement of a block diagram of a scanning antenna using a BFN. As shown in FIG. 2 there are three key elements to a scanning antenna using a BFN. First are the radiating elements, also referred to as the array elements. Second there is the BFN, as shown by a block diagram in FIG. 2. Third there are the beam ports, each beam port provides a separate radiation beam to the system. The important characteristic of a BFN is a set of beam ports that are transformed by the BFN to a set of array ports (radiation elements).

There are a wide variety of passive BFNs but two of the most common are the Butler Matrix and the Rotman Lens.

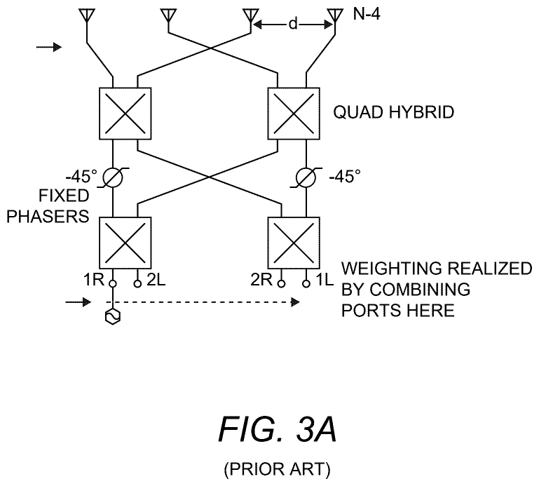

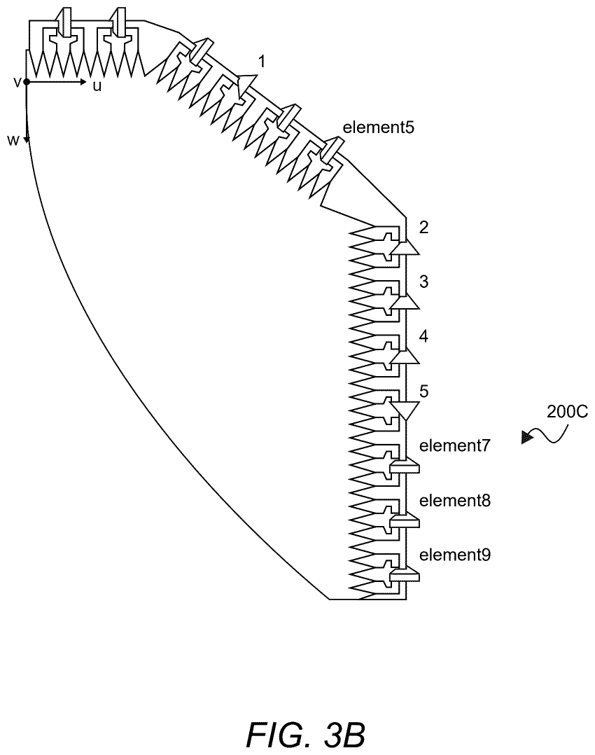

FIG. 3A shows a 4×4 Butler Matrix used to produce 4 output beams, 2 on the left side of the array axis and 2 on the right side of the array axis. As shown a 4×4 Butler matrix consists of quadrature hybrids, or 90-degree hybrids, and phase shifters. The four beams are orthogonal because when an impinging wavefront is at one of the four beam directions all received energy is onto that beam port with nothing into the other three beam ports. A beam that impinges at a location intermediate between two of the orthogonal beams will have energy into multiple beam ports. In this way the 4×4 Butler matrix can be used to scan beams through proper phasing of the energy into the four beam ports. When this is done often a simple combiner is used connecting the beam ports

FIG. 3B shows arrangement 200C, which is an inventive approach like, but as an alternative to, a standard beam former using a parallel plate lens similar to a Rotman lens. The approach is two dimensional where a parabolic surface is used to discriminate between signals from different directions to provide the reverse beam forming function.

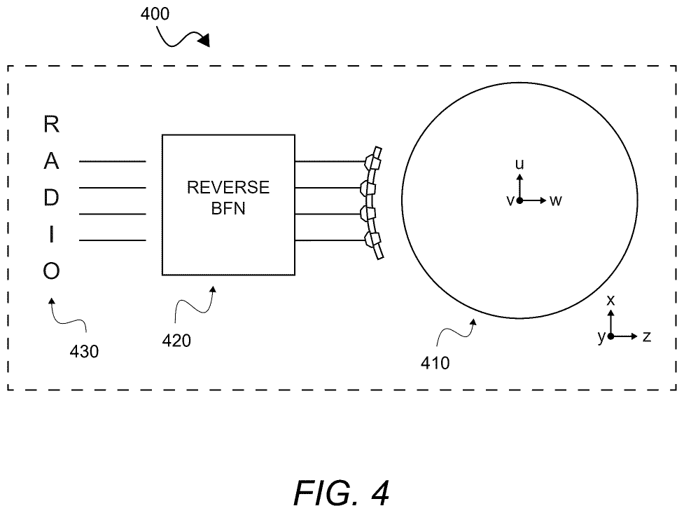

One of the inventive arrangements described here is to use the BFN in reverse. This is shown diagrammatically by arrangement 400 in FIG. 4. The radio shown in FIG. 4 represents one of several more advanced wireless radios that provide a set of amplitude and phase weights (precoding matrix) which are used to create beams using either columns of feed elements (e.g. 8T8R arrangement), or when arrangement 400 is used both for azimuth and a separate set for elevation a two-dimensional array (e.g. 64T64R arrangement). For the 64T64R arrangement (32T32R for each of two orthogonal polarizations) there would be 8 beams in azimuth connected to an 8×8 BFN then 4 of these stacked in elevation each connected to a 4×4 BFN creating 32 ports for connection to a radio with 32 ports for each polarization

The inventive concept uses existing beams from RF lens multi beam antenna system 410 (or other passive multiple fixed beam antenna) that connects the beams entering from the right of the Reverse BFN 420, transforming to the array ports that connect to radio 430. This is the reverse of how a BFN is typically used hence the terminology “Reverse BFN”.

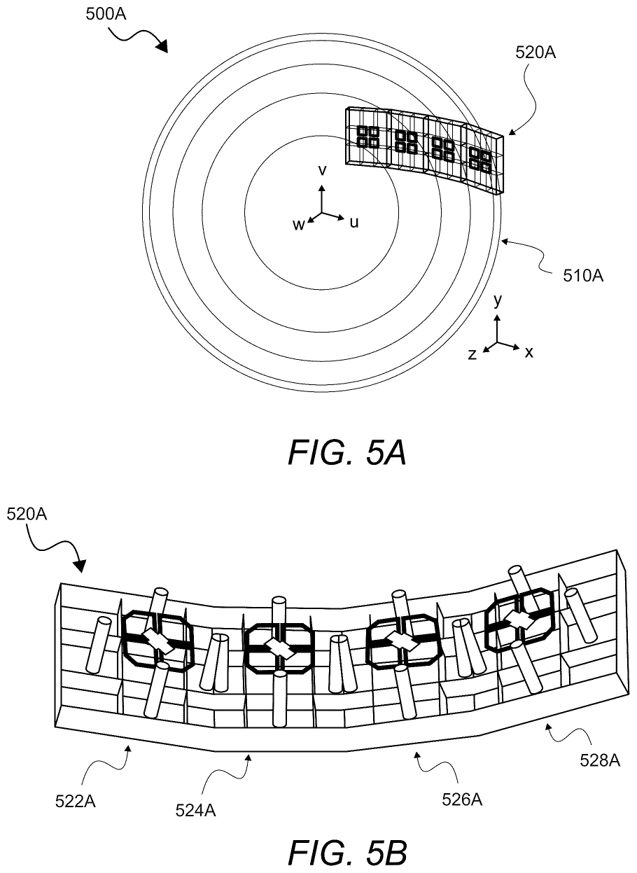

FIG. 5A shows a typical RF lens based multiple beam antenna 500A as one possible embodiment of the inventive concept. This example consists of a five-layer Luneburg lens 510A with four closely spaced feeds 520A to produce beams at −15, −5, +5-, and +15-degrees azimuth.

FIG. 5B shows the details of feed arrangement 520A. The feeds are designed to operate over the 3.3 to 4.2 GHz band. The feed centers (522A, 524A, 526A, and 528A) are spaced approximately 50 mm apart. When used to illuminate a 5 layer 45 cm diameter Luneburg lens four beams are produced at azimuth positions −15, −5, +5, and +15 degrees.

Referring to FIG. 4, it is apparent that these four beams of feed arrangement 420A represent the four connections at the right of the reverse BFN.

Another approach to achieve Lens Beam Forming is through software configuration, hardware configuration (or combination of both) such that a processor (i.e. baseband unit) can interface with standard radio heads to deliver beamforming functionality without having to use a beam-forming multi-element array. In this approach signals generated by the baseband processor/modem are matched to each passively created beam via new base station (BS) configuration created to be compatible with current beamforming signaling standards between BS and user equipment (UE). This allows beam forming functionality while using standard radios and passive multiple beam antennas (such as RF Lens or even a multi-beam phased array antenna, such as butler matrix antenna, Rotman lens, and any other multi-beam antenna).

The signaling flow is compatible with standard non-beamforming radio heads currently used in 4G and 5G wireless networks. Synchronization of active beams for proper UE handling is an integral part of the new BS configuration created to match passively formed beams between base station and UEs. The air interface signal flow follows standard signaling for idle state and active state between the base station (BS) and user equipment (UE). However, a new BS configuration related to creating signals in the baseband processor/modem is loaded into the BS to properly match the RF lens antenna beams. This BS configuration is specially designed to match the air interface signals to each passively formed beam such that only the beam required for connection to the UE being served with either idle state information or active state information is required. This reduces the number of active power amplifiers for a significant savings in consumed power. As compared to non-beamforming BS equipped with multiple passive beams there is a reduction of simultaneous active transmitters, all but one passively formed beam is inactive at a time. This means non-required beams are not transmitting with power amplifiers off until it is time to be the active passively formed beam.

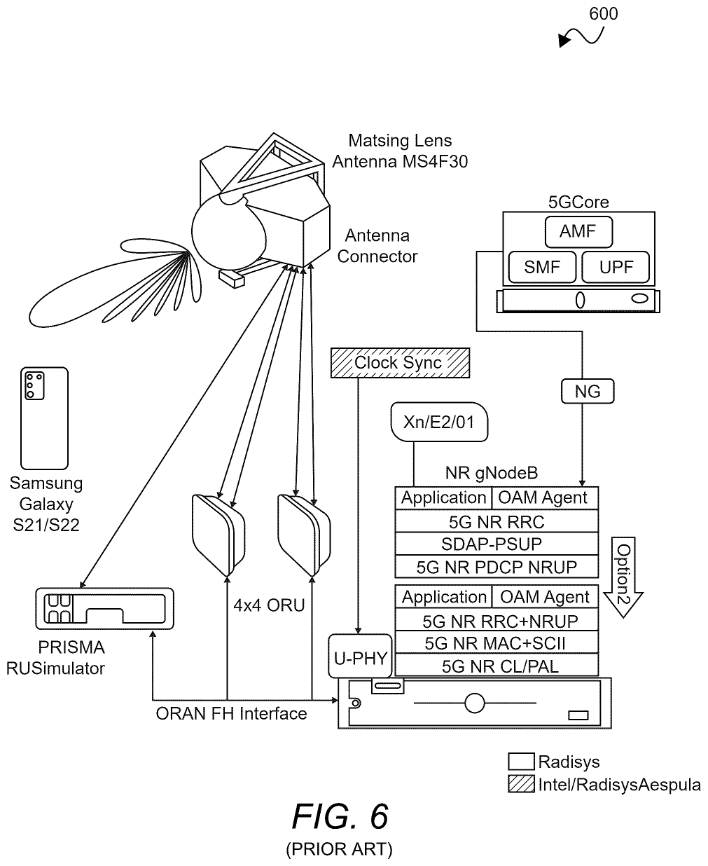

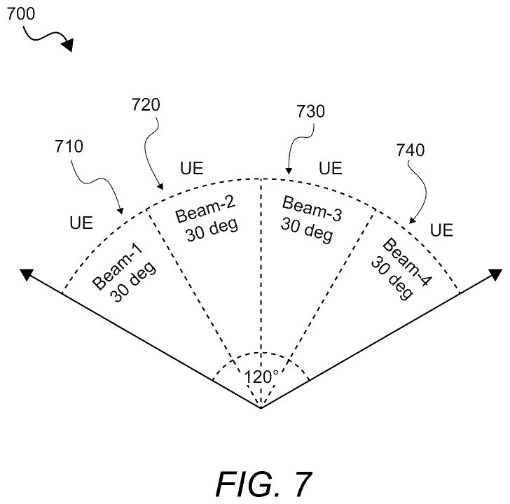

A key to the software and hardware-based solution is the use of standard 4 port radios (or any other standard radio such as 2×2 or 8×8 or others) that are output to a processing unit that adapts to standard 5G network architecture, as shown in system 600 of FIG. 6. This approach is used to scan the beams shown in FIG. 7 as beam 710 (or Beam-1), beam 720 (or Beam-2), beam 730 (or Beam-3), and beam 740 (or Beam-4). This embodiment of the radio access network determines which of the four beams are on at any given time.

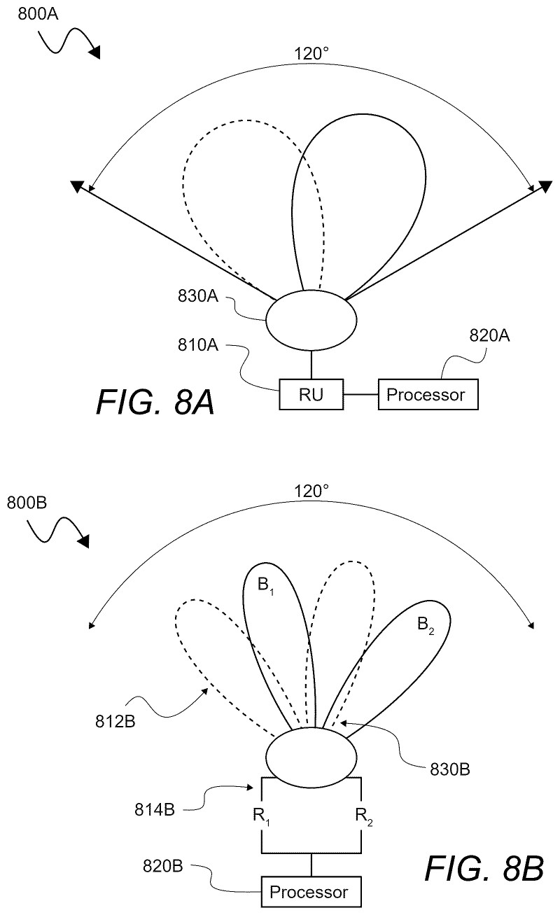

FIG. 8A shows a basic configuration of system 800A, including single 4×4 radio 810A connected to processor 820A and two beam antenna 830A (in comparison to the four-beam approach shown in FIG. 8B). System 800B of FIG. 8B includes radios 812A and 812B coupled to processor 820B and four-beam antenna 830B. In FIGS. 8A and 8B and the following drawings, a beam that is on is represented by a solid line while a beam that is off is represented by a dashed line. Dashed and solid lines can also be used to represent beams have different characteristics, for example different phases or polarities, etc.

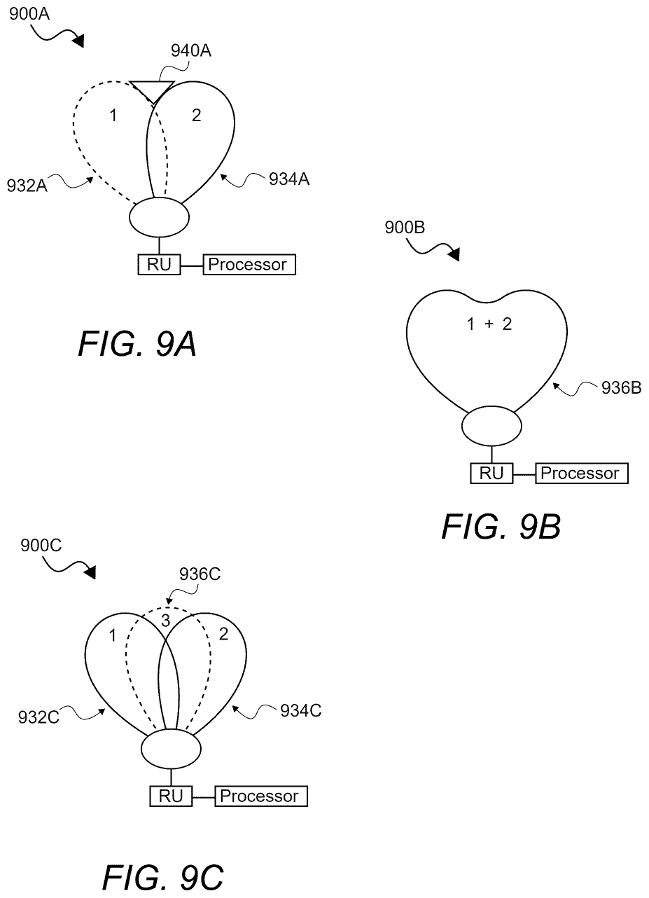

Such systems have the ability to switch between two beams, or even ability to have both beams on at the same time (combined as a single beam) which provides a solution to cover a null (or dead zone) 940A where the two beams (e.g., 932A and 934A) intersect, as seen in system 900A of FIG. 9A, having similar elements as FIG. 9A. FIG. 9B shows system 900B having both beams on at the same time, thus providing continuous beam 936B covering null/gray zone area. Another approach to reduce null/gray area is to introduce a third overlapping beam (different beam cross over), for example adding beam 936C to beams 932C and 934C as shown in system 900C of FIG. 9C.

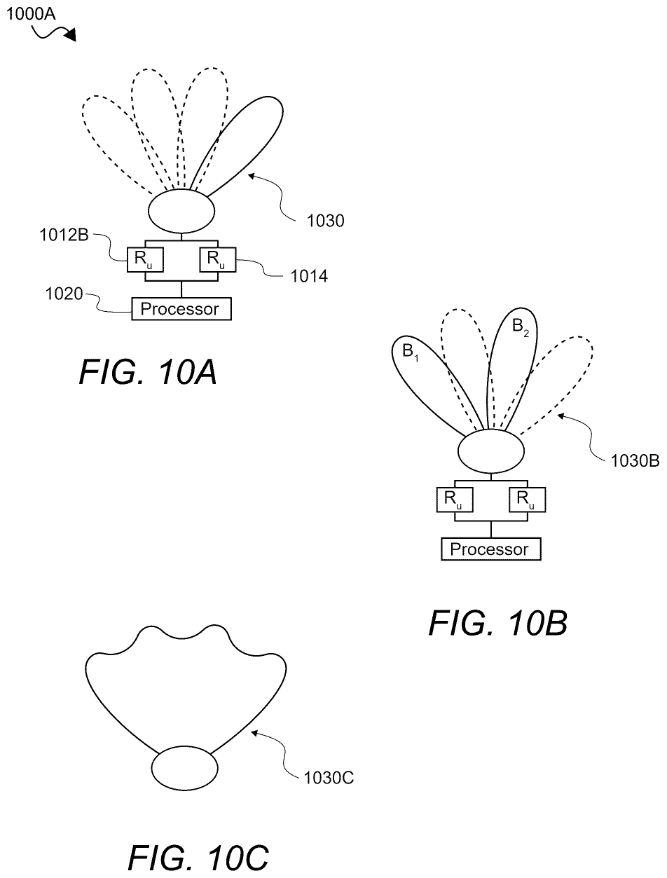

Furthermore FIG. 10A shows system 1000A with processor 1020A coupled to 2 radios, 1012A and 1014A, further coupled to 4 beam antenna 1030A, where a single beam can be on at any point depending on network demands (e.g., FIG. 10A), 2 separate beams on simultaneously as in array 1030B of FIG. 10B, or all beams can be on (combined) as one beam as in array 1030C of FIG. 10C.

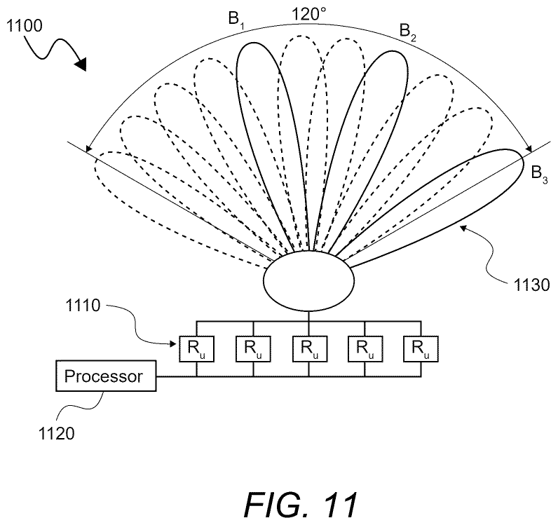

FIG. 11 shows system 1100 having a configuration with multiple radio array 1110 having 5 radios, with beam array 1130 having three beams on at a time. This is shown to demonstrate the scalability of the present invention, the inventive nature is not limited to a certain number of radios or beams, or both.

When two or more beams are on simultaneously, they may also be synchronized between different coverage sectors as described in the air interfaces standards. The approach here is compatible with the standards for intercell interference mitigation.

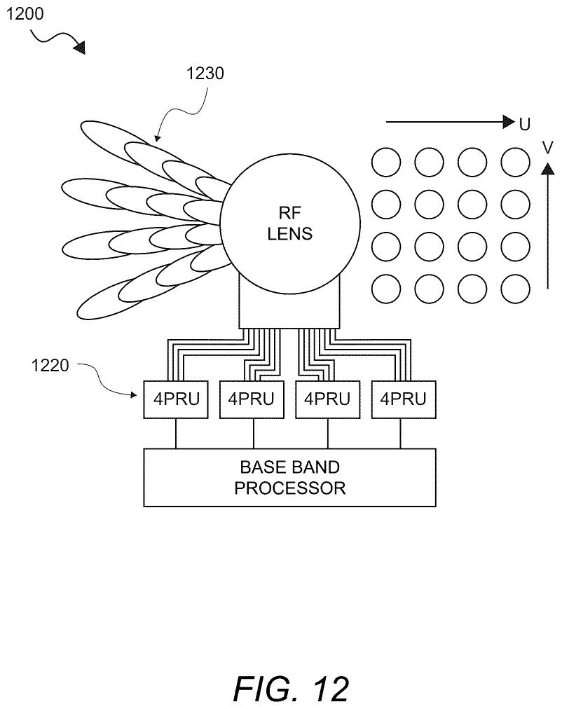

The system allows for dynamic capacity increase, by allowing for multiple beams (see beam array 1130), and therefore multiple radios (see radio array 1110) to be on at the same time in a three-dimension space as shown in system 1200 of FIG. 12. This provides large advantage over current beam-forming systems which work best with a single radio. This system allows for single antenna to provide multiple beams on simultaneously (with multiple radios) when needed or have single beam with single radio when as required by the system.

As described above the inventive software beam forming can be expanded to two dimensions as shown in FIG. 12. System 1200 represents a 16 beam system with four beams in the u dimension and four beams in the v dimension (u-v coordinates simply project the three dimensions beams on a two dimension plane for the convenience of describing the beams) as indicated by the beams 1230 that have a one-to-one mapping to the 16 radio ports shown in 1220.

Another important aspect is the invention is not limited to RF lens antenna. The inventive nature pertains to any multiple beam antenna where the beams are created by means other than the wireless network taking responsibility to provide a set of amplitude and phase weight sets to array elements. This invention takes an existing multiple beam antenna and provides a means for the network to provide the same capability as if radios designed to provide amplitude and phase weight sets were being used, rather standard radio units are used.

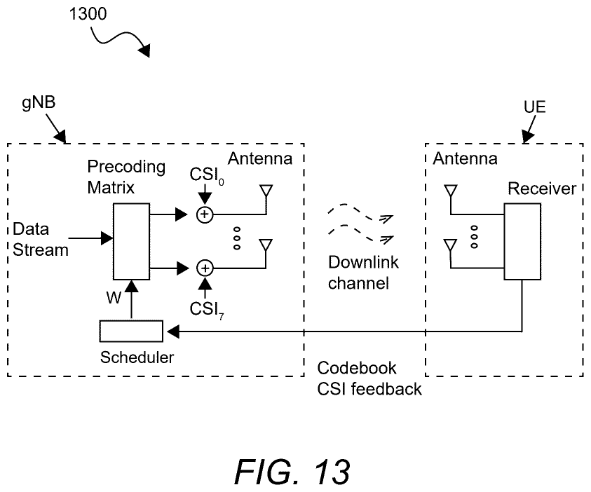

FIG. 13 depicts diagram 1300 of a downlink transmission chain for a MIMO system. CSI feedback is simplified by using a codebook. The precoding matrix, used to map the downlink data stream to the Nₐₙₜ antenna ports, is quantized into a finite number of beams, under the assumption that an array antenna of known dimension is used. The CSI-RS measured at the UE receiver becomes an estimate of the optimal precoding matrix needed in the downlink. The closest precoding matrix from the finite set of beams available in the codebook is chosen. The codebook in the UE maps the precoding matrices to a set of indices. The CSI feedback overhead is reduced by sending the indices of prominent beams to the gNB instead of the received values of the CSI-RS.

There are two types of CSI reporting: type I and type II. Type I may be single panel or multi-panel. The other options are type II or enhanced type II. Type I CSI is a coarse channel report identifying the strongest beam. It is useful for SU-MIMO scenarios. Type II CSI is a rich channel report that provides information about several prominent beams. It is used in MU-MIMO cases. Details can be found in the 3GPP 5G standards document TS 38.214, sections 5.2.2.2.1 to 5.2.2.2.5.

The precoding matrix indicator (PMI) selection is based on the codebook type and antenna panel dimensions. Codebooks are composed of a set of precoding matrices, as described in TS 38.214 Sections 5.2.2.2.1 to 5.2.2.2.3 and Section 5.2.2.2.5. A precoding matrix W can be decomposed into long-term properties of the beam, denoted by W₁, and short-term properties of the channel, denoted by W₂:

W=W₁·W₂

where W₁ is a matrix representing a discrete Fourier transform (DFT) beam for both polarizations. The matrix W₂ can be complex-valued weighting coefficients for the beams in W₁ or co-phasing values between two polarizations.

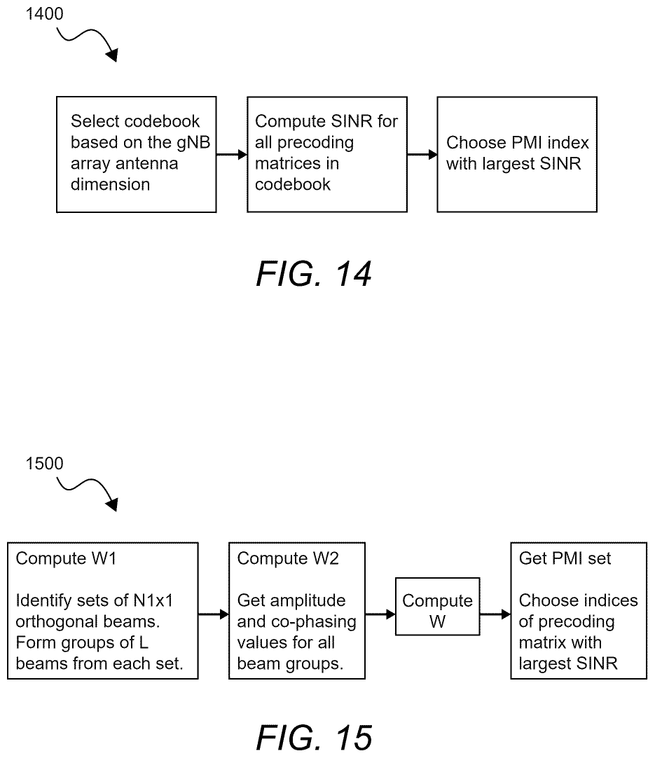

The PMI selection process for type I CSI reporting is shown in flowchart 1400 of FIG. 14. The codebook is selected based on the gNB array antenna dimension. The SINR for all precoding matrices in the codebook are computed and the maximum is selected as the strongest beam.

PMI selection for type II CSI feedback is shown in flowchart 1500 of FIG. 15. The codebook has orthogonal beams whose number is N=N1·N2, where N1 and N2 are the number of orthogonal beams in the horizontal and vertical directions, respectively (note that the total number of antenna ports is 2·N1·N2 for dual polarization). The codebook is over-sampled by O1 and O2, in the horizontal and vertical directions. The selected orthogonal basis, from the O1 O2 sets available, is obtained by offsetting the codebook index by q1 and q2 in the horizontal and vertical directions. From the chosen orthogonal basis set, L beams are selected, where L≤N. This is the computation of W₁. To compute W₂, the amplitude and co-phasing values are obtained by projecting the received CSI-RS vector onto all groups of L beams. The precoding matrix W is computed and PMI indices are selected based on maximum SINR.

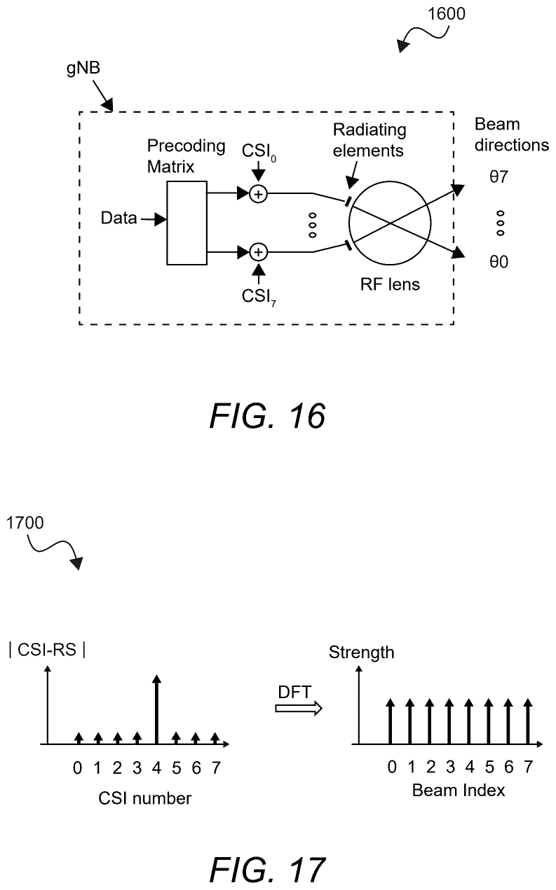

Codebook feedback is designed for array antennas, but it is possible to make it compatible with an RF multiple beam lens antenna (will refer to as lens beamforming), or equivalent multiple beam antenna. The lens beamformer implementation of the downlink is shown in diagram 1600 of FIG. 16. What is different than the array antenna is that each CSI-RS, for a given polarization, corresponds to a beam direction for the lens beamformer. This should make the process of the UE selecting the strongest beam simpler by selecting the strongest CSI-RS received instead of applying DFTs to create the available beams. However, the codebook is not designed to exploit this simplification. The gNB needs to predict how the UE will respond to the lens beamformer CSI-RS, and adjust the CSI feedback to compensate for the unnecessary DFT step done. For convenience, FIG. 16 shows only one polarization of a 16T16R system that has 16 antenna ports and 16 CSI reference signals denoted by [CSI₀ . . . CSI₁₅]. The first group of 8 CSI-RS, [CSI₀ . . . CSI₇], belongs to the first polarization and the second group of 8 CSI-RS, [CSI₈ . . . CSI₁₅], belongs to the second polarization. Each of the 8 beams created has two polarizations.

FIG. 17 depicts data array 1700 illustrating the problem encountered with lens beamforming using codebook feedback for the case of 16T16R (8 beams, two polarizations). Consider a single polarization. The magnitude of the CSI-RS received by the UE appears on the left. There is one dominant beam and the others are small. When the UE attempts incorrectly to convert the CSI-RS to beams using the DFT, the beams appear to have equal strength. As a result, type I CSI reporting would not be of value.

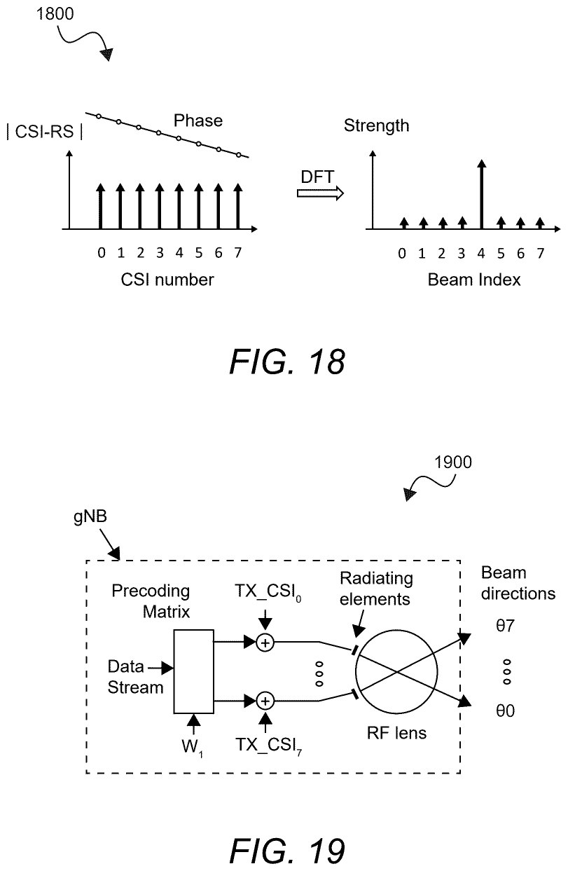

An approach to compensate for this problem is to modify how the CSI-RS is sent from the gNB so that the DFT operation will select the correct beam. The UE expects to see a constant amplitude for all the CSI-RS at the UE receiver and a phase slope that indicates the dominant beam. An example is shown in data array 1800 of FIG. 18. If the lens beamforming system produces a similar CSI-RS pattern, both type I and type II codebook reporting could be used successfully.

FIG. 19 depicts diagram 1900 of a downlink system using lens beamforming with modified CSI-RS. From TS 38.214, section 5.2.2.2.1, the available phase slopes in the type I codebook (single panel, single layer) are

$${B}_{l} = {[ \begin{matrix}1 & {e}^{j \cdot 2 \cdot π \cdot l / ( O 1 \cdot N 1 )} & … & {e}^{j \cdot 2 \cdot π \cdot l \cdot ( N 1 - 1 ) / ( O 1 \cdot N 1 )}\end{matrix} ]}^{T}$$

where 1={0, . . . , N₁·O₁−1}. For the case of 8 azimuth beams (16 ports for dual polarization), N1=8 and O₁=4, we get

$${B}_{l} = {[ \begin{matrix}1 & {e}^{j \cdot 2 π \cdot l / 32} & … & {e}^{j \cdot 2 \cdot π \cdot l \cdot 7 / 32}\end{matrix} ]}^{T}$$

which is a column vector of length 8 where 1={0, . . . , 31}. The available co-phasing between polarizations in the type I codebook is φₙ=exp{j·π·n/2} where n={0, 1, 2, 3}. Table 5.2.2.2.1-5 in TS 38.214 shows the PMI matrix as

$$W = [ \begin{matrix}{B}_{l} \\ {φ}_{n} \cdot {B}_{l}\end{matrix} ]$$

which is a 16-element column vector for 8 beams where the first 8 elements belong to one polarization and the last 8 elements belong to the other polarization. An alternative description of the DFT codebook is

$$W = {W}_{1} \cdot {W}_{2}$$

$${W}_{1} = [ \begin{matrix}{B}_{l} & 0 \\ 0 & {B}_{l}\end{matrix} ]$$

$${W}_{2} = [ \begin{matrix}1 \\ {φ}_{n}\end{matrix} ]$$

where W₁ captures information related to the beam B₁ and W₂ represents the beam weights or co-phases.

The gNB using lens beamforming can send a given CSI-RS on several beams simultaneously to fool the UE. This results in a modified transmitted CSI, denoted by TX_CSI in FIG. 18, which is a weighted sum of all CSI's for a given polarization, where the weights are phase shifts. Ideally, each UE will see a phase gradient that corresponds to the beam that it is connected. Note that TX_CSI captures the information in the W₁ matrix. The information in the W₂ matrix is used to adjust the precoding matrix within the gNB.

Table 1 lists the preferred phase shifts, Δϕ₁, to be applied to each beam for each CSI reference signal. A row in Table 1 represents the phase shifts applied simultaneously to the active CSI-RS on the eight beams. A column in Table 1 is the estimate of the precoding matrix for a given beam, obtained from the CSI-RS received by the UE. For example, the modified transmitted CSI for beam 0, for the first polarization, would be

$${Tx\_CSI}_{0} = {B}_{0}^{H} \cdot [ \begin{matrix}{CSI}_{0} \\ ⋮ \\ {CSI}_{7}\end{matrix} ]$$

where the superscript H indicates conjugate transpose and

$${B}_{0} = {[ \begin{matrix}1 & {e}^{j \cdot {Δϕ}_{0}} & … & {e}^{j \cdot 7 \cdot {Δϕ}_{0}}\end{matrix} ]}^{T}$$

The modified transmitted CSI for beam 0, for the second polarization, would be

$${Tx\_CSI}_{8} = {B}_{0}^{H} \cdot [ \begin{matrix}{CSI}_{8} \\ ⋮ \\ {CSI}_{15}\end{matrix} ]$$

TABLE 1
Phase shifts applied to CSI reference signal as a function of beam direction.

| | Beam 0 | Beam 1 | Beam 2 | Beam 3 | Beam 4 | Beam 5 | Beam 6 | Beam 7 |
|---|---|---|---|---|---|---|---|---|
| CSI 0 | 0 | 0 | 0 | 0 | 0 | 0 | 0 | 0 |
| CSI 1 | Δϕ₀ | Δϕ₁ | Δϕ₂ | Δϕ₃ | Δϕ₄ | Δϕ₅ | Δϕ₆ | Δϕ₇ |
| CSI 2 | 2Δϕ₀ | 2Δϕ₁ | 2Δϕ₂ | 2Δϕ₃ | 2Δϕ₄ | 2Δϕ₅ | 2Δϕ₆ | 2Δϕ₇ |
| CSI 3 | 3Δϕ₀ | 3Δϕ₁ | 3Δϕ₂ | 3Δϕ₃ | 3Δϕ₄ | 3Δϕ₅ | 3Δϕ₆ | 3Δϕ₇ |
| CSI 4 | 4Δϕ₀ | 4Δϕ₁ | 4Δϕ₂ | 4Δϕ₃ | 4Δϕ₄ | 4Δϕ₅ | 4Δϕ₆ | 4Δϕ₇ |
| CSI 5 | 5Δϕ₀ | 5Δϕ₁ | 5Δϕ₂ | 5Δϕ₃ | 5Δϕ₄ | 5Δϕ₅ | 5Δϕ₆ | 5Δϕ₇ |
| CSI 6 | 6Δϕ₀ | 6Δϕ₁ | 6Δϕ₂ | 6Δϕ₃ | 6Δϕ₄ | 6Δϕ₅ | 6Δϕ₆ | 6Δϕ₇ |
| CSI 7 | 7Δϕ₀ | 7Δϕ₁ | 7Δϕ₂ | 7Δϕ₃ | 7Δϕ₄ | 7Δϕ₅ | 7Δϕ₆ | 7Δϕ₇ |

For the case of 16T16R, it is possible to simplify the process of adjusting the CSI-RS signals to get the UE to select the correct beam for the codebook feedback. The codebook oversamples the number of beams by a factor of four, when O₁=4. As a result, there are 32 codebook beams for the 16T16R (which has eight beams, 2 polarizations).

For codebook type I, the goal is to select the dominant beam. Since there are only 8 beams transmitted, one may use a codebook based on 4T4R, where N₁=2 and O₁=4. This means that only 4 unique CSI-RS are needed: two to define the beam and two for polarizations. The beams, for 1={0, . . . , 7}, are defined by

$${B}_{l} = {[ \begin{matrix}1 & {e}^{j \cdot 2 \cdot π \cdot l / 8}\end{matrix} ]}^{T}$$

For the downlink beamforming, the Tx_CSI reference signals for the first polarization become

$${Tx\_CSI}_{l} = {B}_{l}^{H} \cdot [ \begin{matrix}{CSI}_{0} \\ {CSI}_{1}\end{matrix} ]$$

for 1={0, . . . , 7} where CSI₁ is the 4T4R CSI assumed by the codebook. The Tx_CSI reference signals for the second polarization would be

$${Tx\_CSI}_{l + 8} = {B}_{l}^{H} \cdot [ \begin{matrix}{CSI}_{2} \\ {CSI}_{3}\end{matrix} ]$$

What is unusual about using type I is that the transmitted beam directions do not have to match the codebook. The transmitted CSI, Tx_CSI, is acting as a signature of the beam that it matches in the codebook type I rather than defining the actual transmitted beam direction.

In contrast, to use codebook type II effectively, both the beam directions and beamwidths of the transmitted beams should match a subset of the codebook beams. That is, N₁ should be chosen so that the beamwidth of the RF lens matches the beamwidth of an array antenna because the codebook selects beams from an orthogonal group. The corresponding subset of transmitted beams should also be orthogonal (or at least having minimal overlap).

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The recitation of ranges of values herein is merely intended to serve as a shorthand method of referring individually to each separate value falling within the range. Unless otherwise indicated herein, each individual value is incorporated into the specification as if it were individually recited herein, and ranges include their endpoints.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention. Unless a contrary meaning is explicitly stated, all ranges are inclusive of their endpoints, and open-ended ranges are to be interpreted as bounded on the open end by commercially feasible embodiments.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of adapting a beamforming system to a user device using a codebook-based feedback wireless transmission protocol, comprising:
transmitting from a transmitting station a weighted sum of channel state information reference signals (CSI-RS) via at least a first beam;
using information from the codebook to identify a matching beam from among the at least first beam; and
receiving back from a receiving station, an index representing the identified matching beam.

2. The method of claim 1, further comprising using software to identify the matching beam.

3. The method of claim 1, further comprising using firmware to identify the matching beam.

4. The method of claim 1, wherein the transmitting station is a gNB.

5. The method of claim 1, wherein the receiving station comprises a UE.

6. The method of claim 1, wherein the receiving station comprises a 5G-enabled device.

7. The method of claim 1, wherein the weighted sum comprises a phase gradient corresponding to a beam direction.

8. The method of claim 1, further comprising the transmitting station concurrently transmitting multiple instances of the weighted sum of channel state information reference signals (CSI-RS) within a sector.

9. The method of claim 1, wherein the codebook correlates different ones of the indices with different amplitude and co-phasing characteristics.

10. The method of claim 1, further comprising the receiving station demodulating the first beam to identify the matching beam.

11. The method of claim 1, wherein the plurality of beams comprise beams of a dual polarity.

12. The method of claim 1, further comprising transmitting a second CSI-RS via the plurality of beams.

13. The method of claim 1, wherein the transmission further represents a beamwidth of an array antenna corresponding to the first CSI-RS.

14. The method of claim 1, wherein the beamforming system comprises an RF lens.

15. The method of claim 1, wherein the codebook based feedback wireless transmission protocol is designed for an array antenna system.

16. A method of using a beamforming system with an array antenna based transmission protocol, wherein the transmission protocol uses a channel state information reference signal to identify a downlink beam, comprising:
transmitting a first (CSI-RS) via a plurality of beams of the beamforming system, wherein the transmission encodes a phase gradient identifying a beam of the plurality of beams as the downlink beam;
using the downlink beam to transmit information from the beamforming system to the user device receiving the phase gradient.

17. The method of claim 16, wherein the plurality of beams are formed with an RF lens.

18. The method of claim 16, wherein transmission protocol uses a codebook feedback.

19. The method of claim 16, wherein a beamwidth of the downlink beam matches a beamwidth of the transmission protocol.

20. The method of claim 16, wherein the plurality of beams comprise beams of dual polarity.
